(19) United States
(12) Patent Application Publication
(10) Pub. No.: US 2014/0123989 A1
(43) Pub. Date: May 8, 2014

(54) DEVICE AND METHOD FOR VAPORIZING A FLUID

(71) Applicant: THE SAFE CIG, LLC, Los Angeles, CA (US)

(72) Inventor: André Joseph LaMothe, Austin, TX (US)

(73) Assignee: THE SAFE CIG, LLC, Los Angeles, CA (US)

(21) Appl. No.: 13/668,987

(22) Filed: Nov. 5, 2012

(51) Int. Cl. A24F 47/00; H05B 3/02

(52) U.S. Cl. 131/328; 131/329

(57) ABSTRACT

A fluid vaporization device and related method of vaporization are disclosed. A vaporizable fluid is transported from a fluid reservoir to a vaporization chamber via a wick element which extends into both the fluid reservoir and the vaporization chamber. The fluid in the vaporization chamber is then heated by activating a heating element which is disposed, at least partially, within the vaporization chamber. The heating step transforms the fluid stored in the wick element into a vapor, after which it is transported out of the vaporization device via a conduit.

### BACKGROUND

An electronic cigarette, or e-cigarette, is a device that simulates the act of tobacco smoking by producing an inhaled vapor which can bear the appearance, flavor, and feel of inhaled tobacco smoke. Compared to tobacco smoking, e-cigarettes provide an ostensibly safer “smoking” experience by reducing the combustion process that occurs when tobacco is burned, resulting in fewer toxins and carcinogens. This is accomplished through the use of heat to vaporize a liquid solution into an inhalable mist.

A typical e-cigarette includes a wad of fibers which are soaked with a vaporizable fluid. When the user inhales through the e-cigarette, a heating element is used to heat the fluid soaked fibers, vaporize the fluid, and deliver the vapor. However, when the fluid is consumed and the fibers dry up, they can combust or ignite, leaving the user with a burnt taste and releasing toxic chemicals. Therefore, improvements in vaporization technology are needed.

### BRIEF DESCRIPTION OF THE DRAWINGS

FIG. 1 shows an external view of an exemplary vaporization device according to the disclosed embodiment.

FIG. 2 shows a cross-sectional view of the vaporization device of FIG. 1 according to the disclosed embodiment.

FIG. 3 shows a third perspective of the vaporization device of FIGS. 1 and 2 according to the disclosed embodiment.

FIG. 4 shows a variation of the vaporization device according to the disclosed embodiment.

FIG. 5 shows a variation of the vaporization device according to the disclosed embodiment.

FIG. 6 shows a cross-sectional view of the partition portion of the wick element holder of an exemplary vaporization device according to the disclosed embodiment.

FIG. 7 shows an exemplary electronic circuit utilized for the thermal cutoff feature of the vaporization device according to the disclosed embodiment.

FIG. 8 shows an exemplary method of operation of the vaporization device according to the disclosed embodiment.

FIG. 9 illustrates exemplary pore sizes for ceramics according to the disclosed embodiment.

FIG. 10 illustrates exemplary pore sizes for ceramics according to the disclosed embodiment.

FIG. 11 shows external view of an exemplary vaporization device including a cartridge component and a battery component according to the disclosed embodiment.

FIG. 12 shows an internal view of a dual-reservoir fluid cartridge in an exemplary vaporization device according to the disclosed embodiment.

FIG. 13 shows an internal view of a quad-reservoir fluid cartridge in an exemplary vaporization device according to the disclosed embodiment.

### DETAILED DESCRIPTION

While devices and methods are described herein by way of examples and embodiments, those skilled in the art recognize that devices and methods for vaporizing are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

The disclosed embodiments provide devices and methods for vaporizing fluids. The embodiments improve the vaporization process by preferably isolating the fluid reservoir and the vaporization chamber. The liquid in the fluid reservoir can be delivered to the vaporization chamber via one or more wick elements. Various embodiments used to practice the invention are described in greater detail below with reference to the drawings.

### Overview of the Structure of the Vaporization Device

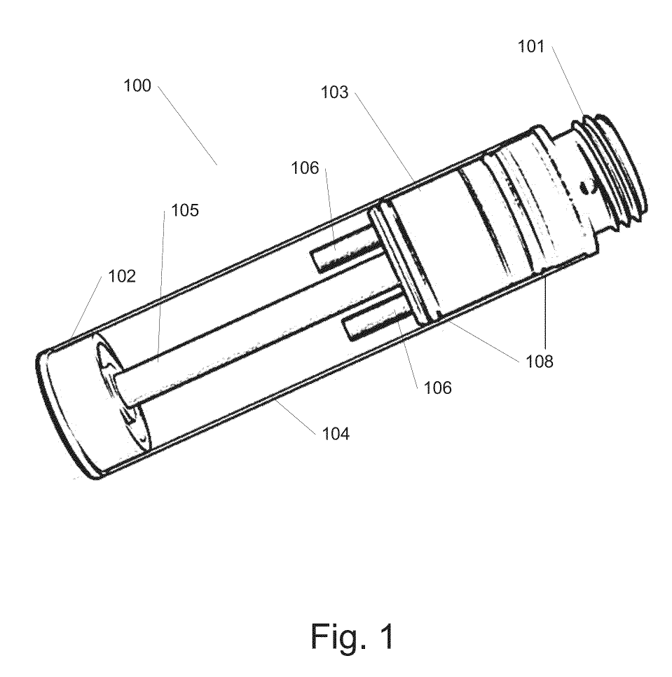

FIG. 1 illustrates an exemplary fluid cartridge for a vaporization device such as an electronic cigarette according to the disclosed embodiment. This cartridge can be referred to as a cartomizer or an atomizer. The fluid cartridge, 100, is adaptable to be coupled to a power source, such as a battery component, at one end, 101. At the other end, 102, is an outlet such as a mouthpiece through which the user inhales the vapor produced by the device. Fluid reservoir, 104, holds the vaporizable fluid, and wick element, 106, is used to transport the fluid from the fluid reservoir, 104, to the vaporization chamber, 103. After the fluid inside the vaporization chamber, 103, is vaporized, the vapor travels via conduit, 105, to the user's mouth at the other end of the cartridge, 102.

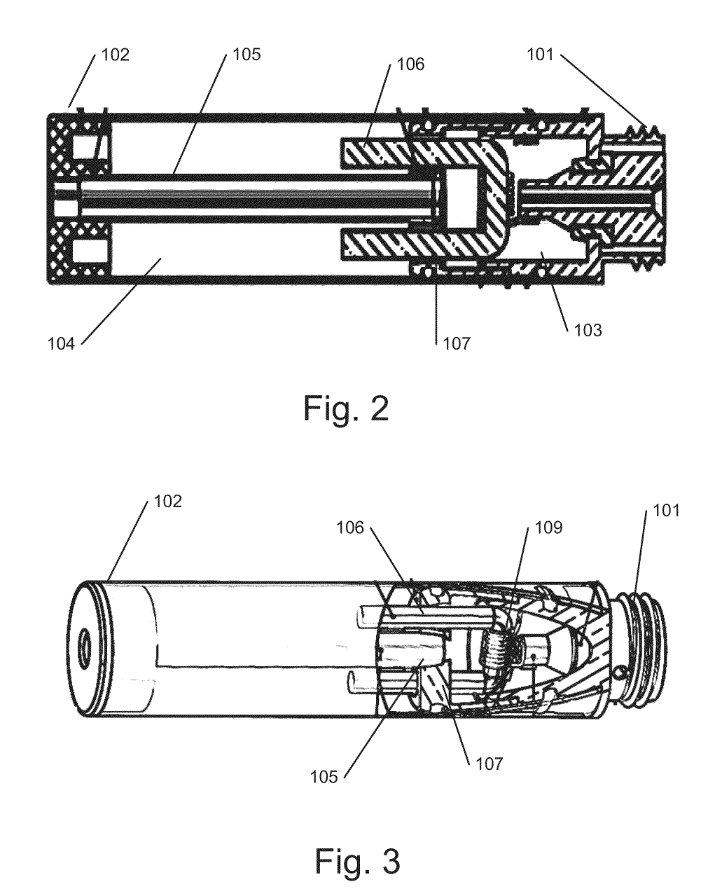

FIG. 2 shows a cross sectional view of the vaporization device of FIG. 1 according to the disclosed embodiment. As illustrated in FIG. 2, the reservoir, 104, and the vaporization chamber, 103, can be separated by the wick element holder, 107, which preferably functions to hold the wick element, 106, in place, and serves as a partition between the reservoir, 104, and the vaporization chamber, 103. As shown in FIG. 2, the reservoir, 104, can be positioned such that it coaxially surrounds the vapor conduit, 105, and the fluid in the reservoir, 104, is kept from leaking out by the partition formed by the wick holder, 107. The specific positional arrangement of the reservoir, 104, and the vapor conduit, 105, can vary as long as the described functions are achieved.

Another perspective of the vaporization device of FIGS. 1-2 is shown in FIG. 3. The outer casing of the vaporization device towards one end, 101, is shown as transparent in the figure so that the components within can be described. FIG. 3 illustrates a heating element, 109, which is shown disposed around the wick element, 106. Heating element, 109, can be a heated coil or any other suitable heating element. When user activates the power source attached to end, 101, for example, by inhaling, the heating element, 109, heats up, causing the fluid present in the wick element, 106, to be vaporized. The vapor is then carried through conduit, 105, to end, 102, where it is inhaled by the user.

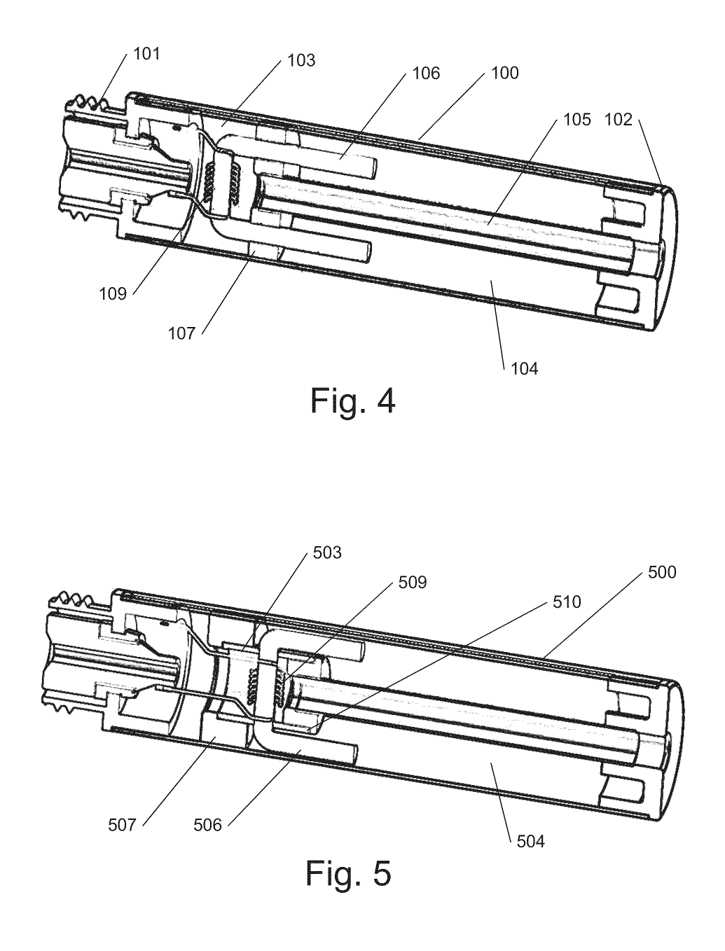

FIG. 4 illustrates another cross-sectional view of the cartridge, 100, of FIGS. 1-3, with end, 101, adapted to couple with a battery component and end, 102, used by the user for inhalation. As discussed in reference to FIGS. 1-3, the disk shaped partition wick holder, 107, seals the fluid reservoir, 104, from the vaporization chamber, 103, and interfaces with the vapor conduit, 105, while holding the wick, 106, in place. Heating element, 109, is used to vaporize the fluid transported into the vaporization chamber, 103, by the wick element, 106.

FIG. 5 illustrates a variation of the design illustrated in FIGS. 1-4. FIG. 5 shows a fluid cartridge, 500, where the vaporization chamber, 503, containing heating element, 509, extends past partition, 507, into the fluid reservoir area, 504. In this cartridge, the wick, 506, is held in place by the vaporization chamber, 503, which is protected from direct contact with the reservoir by barrier, 510, which surrounds the vaporization chamber.

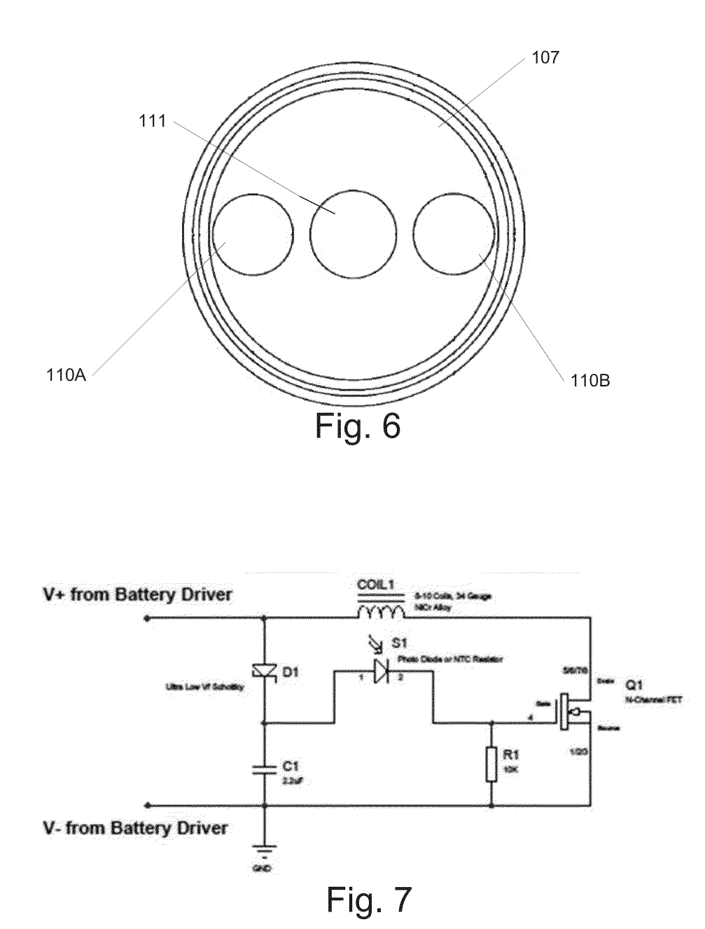

A cross sectional view of an exemplary partition portion and wick element holder, 107, of FIGS. 1-4 is shown in FIG. 6. The wick element, 106, shown in FIGS. 3-4, extends through openings, 110A and 110B, in the partition portion. Additionally, vapor conduit, 105, shown in FIGS. 3-4, extends through the center opening, 111.

### Wick Element Shape and Partition Shape

Although the wick elements shown in FIGS. 1-5 are described and illustrated as being U-shaped, and the partition in FIG. 6 contains two openings for the wick element, devices according to the disclosed embodiments are not limited to such an arrangement. The wick element can be a straight line extending into the vaporization chamber and the reservoir through a single opening in the partition. The wick element can also be L-shaped, multi-pronged, or even in the form of a hollow cylinder which passes through a circular opening in the partition. The wick can also be wholly contained within an opening in the partition and not extend outwards into the reservoir or vaporization chamber. Any design that enables the wick element to transfer fluid from the fluid reservoir into the vaporization chamber may be used, and the relative positions of the wick element and partition openings can vary greatly. The vaporization device is not limited to the embodiment disclosed herein.

### Thermal Cutoff

The vaporization device according to the disclosed embodiment can also include a thermal cutoff, which can also be referred to as a thermal governor. A thermal cutoff can be configured to disengage the heating element when it reaches a certain temperature, thereby preventing overheating or ignition of portions of the vaporization device. Such overheating can occur when the reservoir is empty or when the fibers or wick element contained within the vaporization device are dry.

The thermal governor can be a completely independent unit which can be retro fit into any vaporization device without changing the electronics in the battery, adding a sensor input to the microcontroller in the battery assembly, or changing the firmware. The thermal governor preferably uses an electronic circuit which is passive and is not directly powered, but harvests power from the heating coil drive itself Any suitable thermal cutoff or thermal governor can be used.

The operation of such a circuit will now be described in reference to FIG. 7. When the user drags on the electronic cigarette, V+ and V− from the battery are energized as a DC constant voltage, or a square wave pulse train at 125 Hz, is applied. Initially, transistor Q1 (which can be an N-channel FET) can be switched on by the low voltage applied to the gate by resistor R1, and current flow from V+ thru the heating coil Coil 1, thru Q1, to ground. As this occurs diode D1 is forward biased and conducting current from the battery and siphoning off a small amount of charge which charges C1 to V+'s maximum excursion voltage (usually 3.7-4.1V, the Li-Ion battery voltage). Thus, C1 acts a low power, DC source at the Li-Ion battery potential. The circuit action then operates as follows: as Coil 1 heats up, it will follow a curve that transitions from cold to hot, sustaining a high temperature while the user is dragging, and then cooling when the user releases the drag. Under normal conditions the coil and the amount of light and heat it gives off will come to an equilibrium and fall within a “range” of values when the fluid supply is available. However, once the fluid supply diminishes, Coil 1 will reach higher temperatures and will emit off more light and heat. As it does, sensor S1 (which can be a NTC, negative temperature coefficient thermistor, or a photo diode) will change resistance in response to the high coil temperature. As this occurs, more current will flow from C1 and a higher voltage will be developed at the gate of Q1. At some point, this voltage will pinch off the FET channel and disallow conduction, in essence shutting the coil down and acting as a negative feedback loop.

Therefore, by selecting the value of S1, R1, and the position and geometry of the sensor placement itself, the circuit can be tuned to trip at a specific set point and start disengaging the heating coil, thereby stopping it from overheating when the fluid is empty in the vaporization chamber.

### Operation of the Device

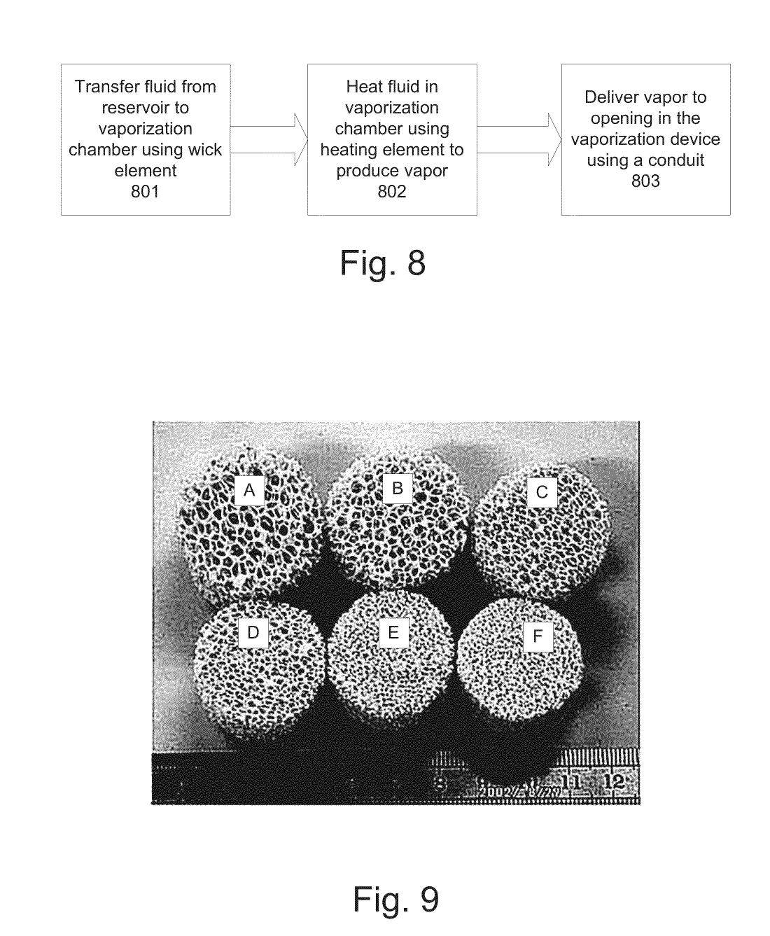

FIG. 8 illustrates an exemplary method of operation of the vaporization device. A vaporizable fluid is first transported from the fluid reservoir to a vaporization chamber through the wick element which extends into both the fluid reservoir and the vaporization chamber in step 801. The fluid in the vaporization chamber is then heated by activating the heating element which is disposed, at least partially, within the vaporization chamber, 802. In embodiments where the vaporization device is an electronic cigarette, the heating element can be activated when the user inhales through an opening in the cigarette. The heating step transforms the fluid stored in the wick element into a vapor, after which it is transported out of the vaporization device via a conduit, 803.

### Wick Element Construction

The wick element can be constructed from any suitable material, such as cotton, polyester, hemp, rayon, metal oxide based fibers, silicon oxide based fibers, or combinations thereof. However, many materials emit toxic chemicals when they combust or overheat. Thus, it is preferred that the wick element be comprised of safer materials that do not combust or do not give off as many toxins when they do combust. One such material, derived from corn, is Polylactic Acid (PLA). PLA is used as a green material in a variety of applications such as bedding and clothing. When PLA fibers are combusted, its by-products are completely safe, yet it retains many of the same mechanical and wicking properties as other synthetic fibers.

Polylactic Acid (PLA) is a polymer made up of many lactic acid (C₃H₆O₃) units. PLA is typically formed in one of two ways: 1) direct condensation of lactic acid, or 2) formation of lactide (cyclic di-lactic acid) followed by a ring opening based polymerization. Provided that PLA undergoes complete and “proper” combustion, one would expect the only products to be carbon dioxide and water. The complete combustion of PLA would result in same products as regular human respiration. In other words, no toxic products would be expected to form when PLA undergoes complete combustion. However, if PLA does not undergo complete combustion then some toxic materials can be produced. Some of these products can be: lactide, acetaldehyde, and n-hexyldehyde. Lactide can cause serious eye irritation, skin irritation and respiratory irritation. Acetaldehyde can causes serious eye irritation and respiratory irritation. Its liquid and vapor are extremely flammable and it is a suspected carcinogen. n-hexyldehyde can cause serious eye irritation, skin irritation, respiratory irritation, and its liquid and vapor are extremely flammable.

It is possible that other compounds can be formed as a result of incomplete combustion. In addition, it is also possible, but highly unlikely, that a product of incomplete combustion can react in the gas phase with other products/side products of a material being “co-combusted” with the PLA. Only a chemical analysis of combustion (either PLA alone or PLA with other materials) would give a complete spectrum of complete and incomplete combustion products.

To avoid the potential risks associated with the combustion of the above-noted fiber materials, the wick element can utilize a non-fiber based material to transport the fluid from the reservoir into the vaporization chamber. For example, according to the disclosed embodiment, the wick element can be at least partially comprised of porous ceramic materials. Ceramic materials can withstand extremely high temperatures (sometimes in excess of 1400 Fahrenheit) and have internal pores than can be used to channel fluids. Furthermore, the size of the pores in a ceramic material can be adjusted so as to control the fluid transfer rate of the fluids being transferred from the reservoir to the vaporization chamber. In one non-limiting embodiment, the pores preferably have an average diameter of less than 100 microns, which can be set by processing techniques, materials, or a combination of the two.

Of course, the wick can be constructed from fibers which themselves are constructed from a ceramic material that will not melt or combust under normal usage. For example, the wick element can be constructed from woven ceramic fibers, in addition to porous or non-porous ceramics.

In more detail, ceramics are materials made from the heating, and cooling of a non-metallic, inorganic substance. Some examples of commonly used ceramics are porcelain, stoneware, and earthware. Other, less common ceramics are used in the sciences for high temperature heating. Some of the scientific purposes are for high temperature reactions that cannot take place in “normal” glassware. There are also reactions in chemistry take place between two (or more), solid metals. The typical way to get two metals to react is to melt them together. Because the temperatures necessary to perform this are extremely high, ceramics are often employed as “reaction vessels.”

Ceramics are also used in a method of compound characterization called elemental analysis. Elemental analysis is a form of compound characterization that gives percentage values for the elements found in a particular substance. Elemental analysis normally takes place by combusting a compound and analyzing the “post-combustion” components. In order to ensure as complete combustion as possible, elemental analysis is typically done at extremely high temperatures (1000+° C.).

### Ceramics: Reactivity and Potential Health Hazards

Ceramics can be used for these scientific purposes because of their lack of reactivity. The compounds used to make most “scientific” ceramics are metal oxides and silicon oxides. Metal Oxides are used in the product of ceramics because they, for the most part, are completely un-reactive to other chemicals. This trend not only holds true for room temperature interactions, but also high temperature interactions. In fact, it would be more likely that high temperatures would destroy reaction components than the presence of a metal oxide in the reaction. Further proof of the lack of reactivity of metal oxides is that metal oxides, typically aluminum oxides (Al₂O₃), are used in compound purification. Silicon oxides are used in ceramics for the same reasons that metal oxides are used (zero-reactivity and high temperature availability), and silicon oxide based ceramics can be used at higher temperatures than other non-metal based ceramics. Most metal oxide ceramics have a melting point greater than 2000° C. while silicon oxide ceramics have a melting point greater than 1700° C. There are also ceramics which have melting points in excess of 3000° C. up to nearly 4000° C.

For the most part, both silicon oxides and metal oxides pose no major health hazards. However, as will be understood by persons skilled in the arts, any substance can be a potential toxin, it all depends upon the route, and amount in the exposure. Aluminum oxide powder is a mucous membrane irritant with an LD₅₀ (lethal dose of 50% of a population) of about 2 g/kg (rat). In other words, a 180 lb human would have to consume about 160 grams of aluminum oxide powder before exposing a potential threat. Silicon oxide powder is also a mucous membrane irritant with an LD₅₀ of about 3 g/kg (rat). This would mean that a 180 lb human would have to ingest about 240 grams of silicon oxide before exposing a health threat. These issues would probably be moot because the oxides present in ceramics are present in an extremely rigid framework rather than as a free-flowing powder.

The process of wicking is similar to the process of capillary action seen in plants; put simply, wicking is absorption. A common example of a simple wicking/capillary action is cleaning up a spill with a paper towel. If you spill something on a counter and place a paper towel on top of the spill, the paper towel will absorb the liquid. Other examples include oil lamps and Zippo type lighters, both of which function by lighting a wick is in contact with the flammable oil or lighter fluid, respectively.

### Ceramics: Wicking and Porosity

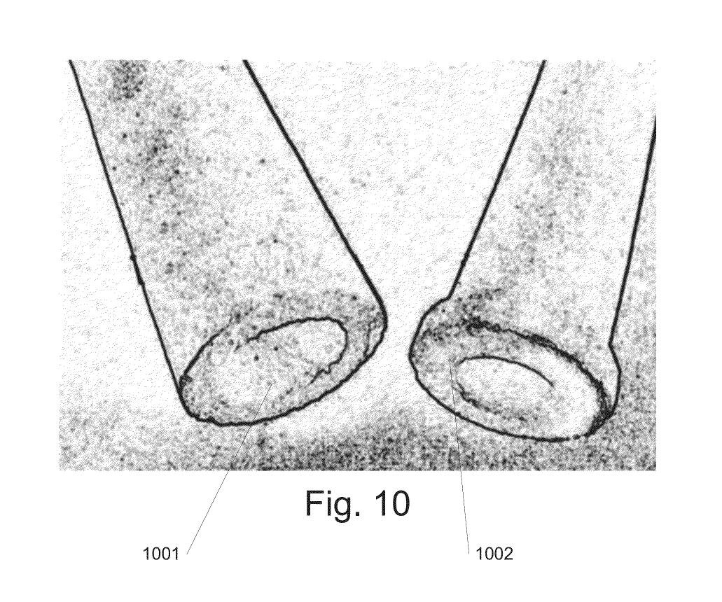

Depending upon the types of materials and combinations of those materials used to make porous ceramics, the pore size and distribution or pores within the ceramics can vary greatly. In fact, there are scientific publications dealing solely with methods of controlling pore size and frequency. Essentially, pore size is an average of the size of the pores within the ceramic (or other material). Some examples of pore sizes are shown in FIG. 9. FIG. 9 shows six materials with different pore sizes, items A, B, C, D, E, and F. As can be seen in the figure, item A has the largest pores, and item F has the smallest, with pores in items B-E getting progressively smaller. FIG. 10 shows two examples of porous ceramic materials with porous ceramic tubes 1001 and 1002.

Even though methods have been developed to control the pore size of a particular material, the final product will not contain pores that are all the exact same size. Therefore, in order to determine what the pore size is for a material, it is necessary to take the average of as many pores as possible.

Pore size plays a very important role in determining the permeability of a substance within the ceramic framework. According to Engblom, et al., (Engblom, S.O., et al. J. of App. Electrochemistry. 2003, 33(1), 51-59.) “Liquids flow through a smooth pore with a velocity that is, at least approximately, proportional to the square of the pore's diameter and, since the volume flow is also proportional to the cross-sectional area of the pore, it is the fourth power of the pore's diameter that determines its volumeric transporting capability. This emphasizes the disproportionate importance of large pores.” According to the Washburn Equation, the distance a liquid travels has an inverse relationship to the viscosity of the liquid. This essentially means that the more viscous something is, the longer it will take to move a particular distance.

### Ceramics: Heating and Combustion

When a material is heated in a ceramic, even at extremely high temperatures, a residue is left in the ceramic. This is typically because no combustion is 100% effective. That's not to say that current methods are inaccurate, it is simply stating that modern methods get extremely close to a complete combustion, but they do not achieve 100% combustion. In the cases of elemental analysis, the combustion residue is simply referred to as “ash.” Regardless of the temperature something is heated to, there will usually be something remaining after combustion. Polystyrene beads, commonly seen in body washes and referred to as “micro beads,” are an excellent example of a material that will not achieve a complete combustion. When elemental analysis is performed on this type of material, it is usually done in a tin encapsulated vessel to ensure the best combustion possible. Even under these circumstances a small amount of material will remain in the heating vessel. In fact, when the elemental analysis data is determined and sent, the percentage of “ash” will be listed in the results.

Combustion products of fibrous wicking materials (cotton fibers, polyester, wool etc.) can be extremely harmful. In fact, one of the combustion products of wool is hydrogen cyanide, a Class 3 chemical weapon. In the cases where fibrous wicks are not used, substitutes for combustion must still be used to aide the burning process. In many cases, liquids themselves are suspending in a casing. When a liquid is used instead of a polymer bead or wick, the same rules will apply: even the best of combustions will leave a residue. Even though a liquid will probably have a lower boiling point than a solid there will be a residual “ash” or other substance left in the container. A liquid such as propylene glycol (Boiling point˜190° C.) will certainly combust under extreme heating conditions, however a “char” will definitely remain in the vessel in which it was burned. This char is residual carbon and possibly, polymeric forms of the propylene glycol. Because the identity of these products is not clearly known, it is difficult to tell whether or not the combustion products are life-threatening if ingested. However, the point may be entirely moot if the residue is encased within the portion of the vessel being heated. For the most part though, if an item is safe to consume on its own, or with a combination of other safe to consume materials, their combustion products, while unpalatable, would also be non-life threatening to consume.

Combustion Hazards: Ceramics vs. Fibers

Table 1 sets forth a list of the typical melting points for ceramics and representative combustion temperatures of various fibers as well as their associated health hazards.

TABLE 1
PROPERTIES OF CERAMICS AND OTHER MATERIALS

| | | | Potentially Toxic | |
|---|---|---|---|---|
| | Flash/Ignition | Melting | Combustion By- | |
| Material | Point (° C.) | Point* (° C.) | products | Health Hazards |
| Aluminum | N/A | ~2050° C. | N/A | Irritant |
| dioxide based | | | | |
| ceramic | | | | |
| Cotton | ~250° C. | N/A | CO₂, CO | Asphyxiation at |
| (cellulose) | | | | high levels |
| Hemp | Decomposition | N/A | NO, NOₓ, SO₂ | Irritation, burns, |
| | | | | labored |
| | | | | breathing. |
| Polylactic acid | Decomposition | ~150° C. | lactide, | Irritants |
| (PLA) | | | acetaldehyde, | |
| | | | and n- | |
| | | | hexaldehyde | |
| Polyester | 220-268° C. | 432-488° C. | Formaldehyde, | Carcinogens |
| | | | methane, | |
| | | | acetaldehyde, | |
| | | | benzene, | |
| | | | toluene, xylene, | |
| | | | styrene, | |
| | | | napthalene, | |
| | | | benzoic acid | |
| | | | derivatives, | |
| | | | phthalates | |
| Silicon dioxide | N/A | ~1750° C. | N/A | Irritant |
| based ceramic | | | | |
| Wool | ~230° C. | N/A | HCN**, CO, CO₂ | Death |

*Some melting point data is unavailable.
**Most dangerous by-product

### Sealing Elements

When a rigid wick element is used, such as a porous ceramic material, a sealing element can be used to maintain a liquid seal between the wick element and the partition. Such a sealing element can be placed in between the wick element and the inner surface of the openings in the partition to ensure that fluids from the reservoir cannot leak into the vaporization chamber. The sealing element can also be constructed so that it makes contact with both the wick element and the partition but is not in between the two, such as an L-shaped sealing element. Any suitable sealing element can be used. For example, the sealing element can be comprised of a silicon axial shock bushing. Such a bushing can hold the fluid seal, and would have the advantage of allowing a rigid wick element, such as one that is constructed from a rigid porous ceramic material, to move around without breakage.

### Cartridge and Battery Electronic Components

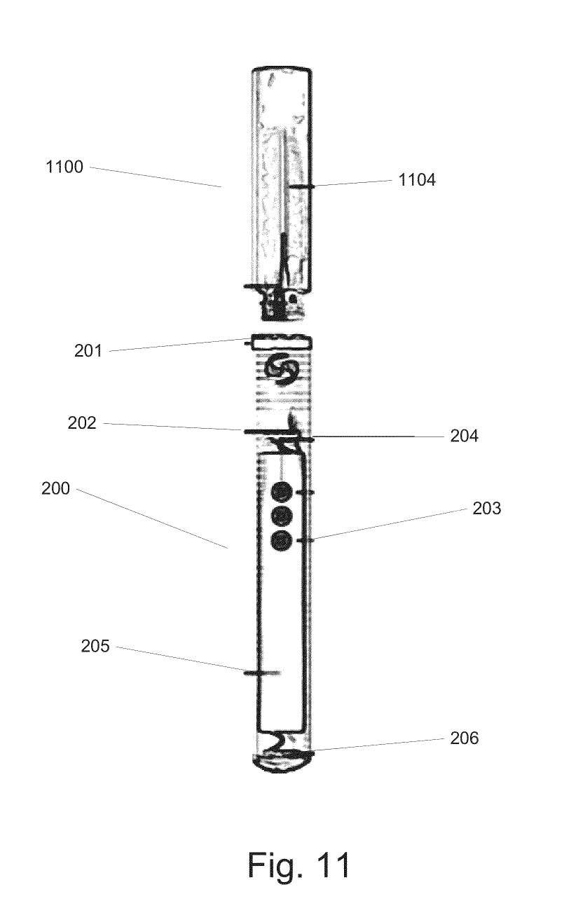

FIG. 11 shows an external view of the fluid cartridge 1100 and the battery component 200 used with the vaporization device according to the disclosed embodiment. The battery component 200 includes an inhalation sensor 202 for detecting when the user inhales through an opening in the cartridge which can be attached to the battery. The inhalation sensor can be either a digital on/off sensor or an analog flow sensor, allowing the user to drag harder and generate more vapor. If an analog flow sensor is utilized, it can have a discrete number of sense settings, such as low, medium, high, or a continuous range.

Additionally, a microprocessor or microcontroller 204 manages the functions and operations of the battery component 200 and may administer such functions and operations through firmware loaded on a storage device that is part of the battery component. The actual battery 205 in the battery component 200 may be any suitable battery, including standard batteries such as an alkaline battery, or a longer lasting battery such as a lithium battery, nickel cadmium, or an advanced lithium ion battery. The battery 205 may be rechargeable. For example, the battery component 200 can be inserted into a recharging station which refills the battery 205. The battery 205 may be removable from the battery component 200, so that it can be replaced or recharged.

Additionally, the battery component 200 may include a charge indicator 201. The charge indicator 201 can be in the form of a light ring that glows a particular color or a light bar under the exterior surface of the battery, so as not to be overt. The indicator 201 can light up once the user starts using the product, and then indicate charge, so the user knows how much battery life he has.

Of course, battery component 200 and fluid cartridge 1100 can be integrated into a single component. For example, a single device can include all of the features the fluid cartridge 1100 and the battery component 200, and users can refill the cartridge from a separate fluid source or reservoir to continue using the device, or discard the device after using it.

### Cartridge Identification

As discussed above, a fluid cartridge 1100 containing the vaporizable fluid in a fluid reservoir 1104 is connected to the electronic battery component 200. The cartridge 100 may have electronic components built in so that it can communicate with the microcontroller 204 that is part of the battery component 200. For example, the cartridge 1100 can send a signal out to identify what kind of cartridge it is or what the specific electronic ID of the cartridge is to the microcontroller 204 on the battery component 200, or a cartridge identifier module can be built to uniquely identify a type of cartridge so that the microcontroller 204 on the battery component 200 can make a determination regarding the type.

The cartridge identifier module feature can be implemented via one or more resistors on the cartridge which can be interrogated by an analog-to-digital (“A/D”) converter or other electronic means on the battery component. Based on the RC charging circuit in the battery, this information can be used to determine the resistance of the resistor, and therefore identify the cartridge. In this way, the resistance values of a resistor or group of resistors can be used as the identifier for the cartridge.

The resistance values can encode information in a binary format which is decoded by the microcontroller in the battery component. For example, if the flavor cartridges are such that there are four possible flavors and each flavor comes in two different nicotine strengths, then there are a total of eight possible values that need to be encoded in the resistance values. This information can be stored in three bits. If the analog to digital converter in the microcontroller can only accurately differentiate values of at least 10 bits, the possible resistance values can just be multiplied by a factor of 1024, which ensures that the possible resistance values are each high enough to be distinguishable from each other to the analog to digital converter connected to the microcontroller. So if a battery component connected to a cartridge runs a small current through the one or more resistors on the cartridge and the resistance of the one or more resistors is approximately 2048, then the microcontroller will register that this cartridge is the second variation out of the eight possible cartridge variations, if the resistance of the one or more resistors is approximately 3072, then the microcontroller will register that this cartridge is the third variation out of the eight possible cartridge variations, and so on.

Of course, a variety of cartridge identifier modules are possible. The cartridge 1100 can contain a microchip with a wireless transceiver which communicates information to the microcontroller 204 on the battery 200 when it is activated. The wireless communication can be any known form of communication, including near field communication, Bluetooth, or others.

Using these techniques, many values can be identified relating to the cartridge, including information about manufacturing date, batch number, and other related manufacturing specific indicators. This information can then be used to adjust the operating characteristics and firmware in the battery component 200 of the device.

### Light Transmission Device

The battery component 200 can also include one or more LED or other light transmission devices 206 (“LTD”) that are connected to the microcontroller 204. The LTD 206 can illuminate when the user inhales on the fluid cartridge, thus mimicking the appearance of a cigarette. This feature can be utilized in conjunction with the cartridge identification methods discussed above to produce a unique light signature for different types of cartridges. So, for example, each cartridge can have a specific blink/display pattern which is displayed through the LTD 206 to indicate characteristics of the cartridge. These characteristics can include, for example, the strength of a particular component in the fluid in the cartridge, the flavor of the cartridge, or the brand or type of cartridge. So if a user has a cartridge with generic labeling, and they wish to determine or confirm some characteristic of it without actually using it, they can just insert the cartridge into the battery component 200 and observe the pattern of lights emitted on the LTD 206 to verify whichever characteristics they wish to check.

The LTD 206 can be configured to display multiple colors and this functionality can be used for different purposes. For example, a user can insert a cartridge and the light transmission device can flash red to indicate the flavor is strawberry, or green to indicate the flavor is apple. Red can indicate regular flavor, whereas green can indicate menthol. Many variations are possible.

The LTD 206 can be used in conjunction with, or in place of, the battery indicator 201. For example, the LTD 206 can flash a certain pattern or show certain colors when the battery is half full, or close to empty. The LTD 206 can also be used implement intelligent functionality, such as alerting a user when to stop using the device, for example, after a predetermined or user-defined period of time has passed from the user's first inhale, or after a predetermined or user-defined number of inhales.

### Control Interface

The battery component 200 can have mechanical and/or electronic control interfaces 203 which allow users to adjust the performance and behavior of the battery component 200. For example, the interface 203 in FIG. 11 can be a capacitive touch sensor built into the battery component 200 so that the user can slide their fingers over a specific portion of the battery section to adjust one or more characteristics. These characteristics can include, for example, the temperature of vaporization. Of course, the interface can be a mechanical or tactile interface, such as buttons, knobs, or sliders. The input from the interface 203 is read by the microprocessor 204 and used to adjust the behavior of the battery component 200 and firmware accordingly.

### Bi-Directional Communications

The battery component 200 may be implemented so that users can both upload information, settings, and profiles to it, as well as download information from it. For example, the battery component 200 can be equipped with a wireless transmitter, Bluetooth transceiver, or can include a communication interface for connecting via USB or a network interface to a computing device of the user.

The user can access the firmware on the battery component 200 through their computer or through a website, and adjust the settings to suit their preferences or to suit a particular fluid cartridge. For example, a new flavor cartridge might come out that requires a different heating profile for maximum flavor, thus the customer can log onto a website or open an application on their computer, plug the battery component 200 in via USB or potentially make a direct connection to via a wireless/Bluetooth or cellular connection and download the new profile to the unit. Another example is if the user wants to limit or reduce their intake. The user can use predefined settings to adjust the maximum amount of fluid that can be vaporized in a given session or a period of time, so that their intake is limited.

This feature allows users to use a PC, mobile device, or other computing device to upload information, firmware updates, and other application or behavioral software updates to the battery component 200. With this technology, users can modify, update and customize their products, as well as download/upload information to and from the product. For example, some customers as part of a smoking cessation program might want to limit their usage of the fluid vaporization to 10 times a day for no more than 20 drags. This can be programmed into the battery component via a PC, mobile device, and the like.

Additionally, the storage on the battery component 200 can keep track of statistics relating to user utilization of the device which can be made available to the user. The storage can log how often the device is used, frequency and intensity of use, number of cartridges used, types of cartridges used, cost of cartridges, and any other use related information. The user can then access this information either over a wireless communication link, or by accessing the storage on the battery component 200 through a communication interface. The information can also be transmitted by the battery component 200 to an online repository which is accessible to the user.

### Multi-Reservoir Cartridge

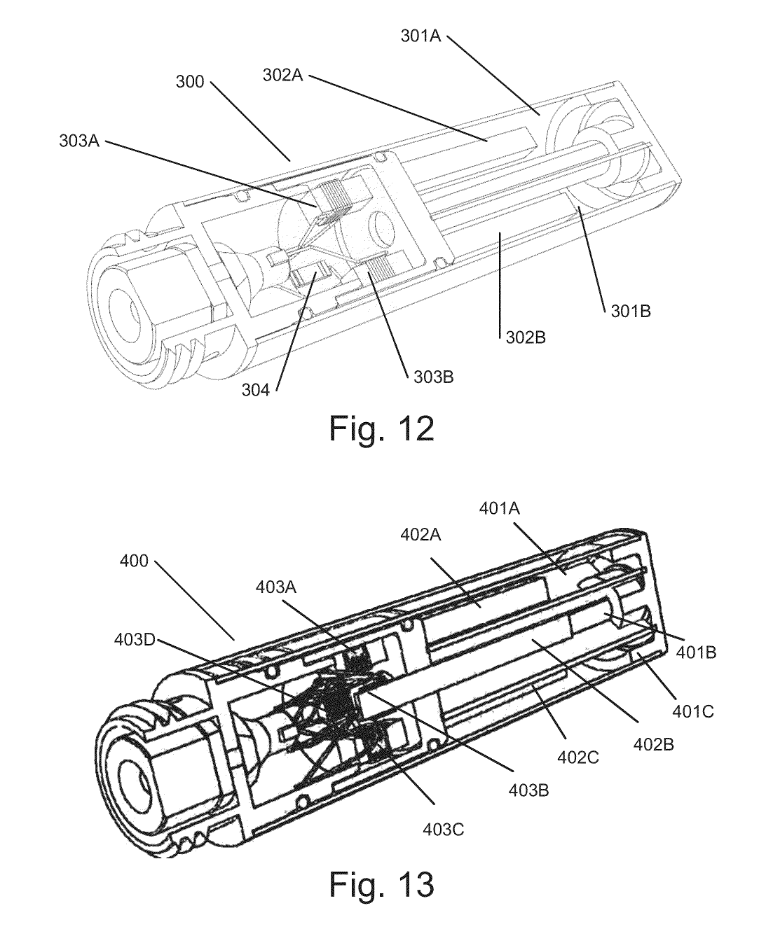

The cartridge component can include more than one fluid reservoir, thereby allowing more than one type of fluid to be vaporized. FIG. 12 shows a cartridge 300 having two fluid reservoirs, 301A and 301B, two wick elements, 302A and 302B, and two heating elements, 303A and 303B. Each of the wicks can be connected to a corresponding fluid reservoir and heating element, allowing the vaporization of two different fluids in the same cartridge.

Of course, many variations are possible. The cartridge can have multiple reservoirs and only one wick element and one heating element. The cartridge can have four reservoirs with two wick elements and two heating elements so that each wick extends into two reservoirs, or be configured such that one wick extends into three reservoirs and the second only extends into one reservoir. In FIG. 12 a single vaporization chamber is shown, but the cartridge can have a plurality of vaporization chambers so that the heat generated from one heating element for a first wick does not indirectly cause vaporization of a fluid in a second wick.

Each of the fluid reservoirs, 301A and 301B, can contain a different type of fluid. As a result, users can produce a plurality of different composite vapors from the two different fluids by vaporizing each fluid in different proportions. Alternatively, the fluids can be mixed in a separate mixing fluid reservoir which is connected to the vaporization chamber with a single wick. The cartridge 300 can also have one or more onboard switches or other communication interfaces as discussed above which allow users to customize the proportion of fluids being vaporized through the cartridge itself.

The cartridge 300 can also include a cartridge identifier module 304 which operates similarly to the cartridge identifier module discussed earlier. By identifying the cartridge, a microcontroller on the battery can determine the proportion of the fluids in each reservoir to vaporize when the user inhales. Additionally, users can specify or adjust what proportion of each of the fluids to vaporize to allow for custom control of the vapor mixture by adjusting the settings or profiles from the battery component. For example, a user can have a fluid cartridge that has reservoir for nicotine containing fluid and a reservoir for flavored fluid. The user can adjust the settings on the battery component or the cartridge itself to increase or decrease the amount of nicotine they would like to inhale with each drag.

FIG. 13 shows a multi-reservoir cartridge, 400, which has four fluid reservoirs and four wicks, although only three reservoirs, 401A, 401B, 401C, and three wicks, 402A, 402B, 402C, are visible in the figure. Four heating elements, 403A, 403B, 403C, and 403D, are used to heat each of the wicks. The fluids from each of the four reservoirs can be vaporized in a plurality of different proportions to produce a plurality of composite vapors. For example, if the cartridge has four different fluids that a user wants to vaporize to generate a composite vapor v, then the final mixed vapor that user would inhale is a linear combination as described below.

Assuming the fluids are Fluid₁₋₄ and the Control/Modulation Signals are h₁₋₄, the composite vapor ν can be calculated as follows:

ν=β*(h₁*Fluid₁+h₂*Fluid₂+h₃*Fluid₃+h₄*Fluid₄),

where the multiplier β illustrates that the overall mixing might have nonlinearities, and itself may be a function of the heating signals and fluids.

Of course, as discussed earlier, any number of fluids or ratios of fluids may be utilized to produce a composite vapor. For example, a four reservoir cartridge can have three reservoirs with different flavors that are connected to a first wick and heating element and a fourth reservoir containing nicotine fluid which is connected to a second wick and heating element. In that situation, the composite vapor v can be calculated as follows:

ν=β*(h₁*(Fluid₁+Fluid₂+Fluid₃)+h₂*Fluid₄).

Of course, the multi-reservoir cartridge can be formed as part of a single unit which also integrates the battery component and does not necessarily have to be a separate component. Any number or combination of reservoirs, types of fluids, wicks, and vaporization chambers are possible, limited only by physical space and construction techniques.

Additionally, any or all of the features discussed above relating to cartridge and battery electronic components, cartridge identification, light transmission devices, physical control interfaces, bi-directional communications with users and other devices, and different profiles and settings of the firmware in the battery component, can be utilized in conjunction with the multi-reservoir cartridge.

For example, if a cartridge has two fluid reservoirs with two flavors, apple and carrot, the user can utilize controls on a battery component either connected or integral to the cartridge to adjust the amount of each fluid vaporized per drag. The user can upload settings regarding different temperatures to vaporize the two fluids at. If the fluid for the apple flavor is running low, the LTD can flash green, and if the fluid for the carrot flavor is running low, the LTD can flash orange. Many variations and combinations of features are possible.

### Vaporization Chamber Sealing Members

It should be noted that the vaporization chamber may be manufactured separately from the other components of the vaporization device. When this occurs, the vaporization chamber can be inserted, for example, into a larger casing which can house the fluid reservoir. In order to provide a tight fluid seal between the outside of the vaporization chamber and the inside of the external casing, one or more sealing members may be placed on the outside of the vaporization chamber. Exemplary sealing members can include O-rings, which are circular bands that encircle the outside of the vaporization chamber, and the like. FIG. 1 illustrates the use of two of these O-rings, 108. Additionally, the vaporization chamber may be fitted with grooves for the sealing members so that the addition of sealing members such as O-rings does not alter the external profile of the vaporization chamber and allows for easier insertion of the vaporization chamber into the external casing.

### Medical Applications of the Vaporization Device and Fluid Cartridges

The fluid vaporization device and cartridges disclosed herein are not limited to nicotine related fluids and can be used for a variety of different medical applications. For example, inhalers are very common devices used to deliver medication to the body via the lungs. The cartridge components and battery components disclosed herein can be utilized to administer medication to an individual in the same way as an inhaler. For example, by using the multi-reservoir cartridge, a patient or a doctor can manage the doses for and/or administer multiple different or complementary medications with a single device. One example of this would be an asthma inhaler cartridge that utilizes multiple different types of steroids or a steroid and a bronchodilator to prevent an asthma attack. The user of such a cartridge can manually adjust the dosages of different medication fluids in the cartridge either through the cartridge or via a battery component or through a communication interface, so that they can tailor the dosage to their specific symptoms.

Additionally, the bi-directional communication interface feature would enable users and their doctors to track usage, dosage, and effectiveness of different drug cocktails. For example, if the device is an inhaler which a patient is trying for the first time, the usage information, such as number of drags or amount of medication fluid used over a period of time can be logged and uploaded to a website, where the patient or their doctor can determine the effectiveness based on usage.

The ability to adjust vaporization settings remotely would be useful in controlling dosage for patients. A doctor, pharmacist, nurse or other medical professional can send an instruction to the device to lower the amount of fluid that is vaporized per drag to lower the dosage of a particular drug when the patient is showing improvement, or if the patient is having adverse reactions. Similarly, the medical professional can send an instruction to the device to limit the number of inhales in a specific time period to prevent abuse of potentially addictive drugs, such as opiates or other painkillers. The number of inhales, or doses, can be pre-authorized, and after a certain amount the device can deactivate until more doses are authorized.

In the case of a fluid cartridge with multiple reservoirs, the medical professional can remotely modify the ratios of the different drugs to provide a different drug cocktail to the patient at each stage of illness or recovery. Of course, all of these instructions or profiles can be entered directly by the patient as well.

In one example, the device will be able to communicate to a PC or mobile device wirelessly via blue tooth, wi-fi, infrared, or cellular technology. Additionally, some devices may have a wired connection such for medical applications such as a USB cord or other interface which connects to the PC directly or other USB host device and is used as a medical appliance for the administration of drugs in a controlled fashion via vapor inhalation. In one application, the device can be permanently connected to the USB cable or other interface, and the user can attach new loads/refills to the device. The wired connection can be used to provide power to the device, and the device can monitor user inhalation patterns and compute air flow as user inhales medicines. The device can be designed so that the user will not be able to use un-authorized medical fluids. In this instance, only doses, fluids, and fluid mixtures that have been enabled and authorized by the doctor or medical professional for the device will operate when plugged in.

### Adaptive Control and Configuration

Since the fluid vaporization device is preferably able to log many operating and usage characteristics over time, the device may intelligently adapt to certain usage patterns or operating characteristics. Such operating characteristics and usage patterns can include, for example, the temperatures of the one or more combustion chambers, the user's drag intensity, the user's rate of fluid consumption and times of peak consumption, and/or the user's consumption of certain types of fluid cartridges or specific fluids in a multi-reservoir cartridge.

The continuous logging of usage information and operating characteristics can be used to adjust the user's experience by manipulating the operational settings of the fluid vaporization device in real-time. The user's previous usage and experience can be used with the operating characteristics in a closed loop adaptive controller configuration to adapt to the user's usage patterns and optimize or otherwise alter the functionality of the fluid vaporization device.

Such changes can be as subtle as changing the animation on the LTD, elongating the maximum allowable drag lengths, changing the heating profile, and/or mixing ratios of fluids, and so forth. For example, if the device determines that the user puts a lot of vacuum pressure on the mouthpiece and thus tends to overheat the unit with its default settings, the device can adjust the heating temperature, so that the user won't overheat the system anymore. If the fluid vaporization device is a medical device, such as an asthma inhaler, the device may determine that the user requires too many inhalations to relieve an asthma attack and increase the dosage of the medicinal fluids in the reservoir to increase the effectiveness of the device in an emergency situation. Many variations are possible, and these examples are provided only to show the nature of the adaptive control feature.

### Variations of the Device and Device Shape

Although the embodiments disclosed herein show the vaporization device as an electronic cigarette, the vaporization device is not limited to such a purpose or shape. The vaporization device can be an electronic cigar or other “smoking” device, an anesthetic vaporizer, a nebulizer, or any other vaporization device which heats a fluid with a heating element to produce a vapor.

The device can also take on any shape or form factor and is not limited to the physical dimensions disclosed herein. For example, if the fluid vaporization device is used as a medical device, it can be constructed to resemble an inhaler or other medical device that a user is accustomed to. The battery can take the place of the medicine compartment that is typically attached to the inhaler and the inhaler mouthpiece component can house the cartridge. The device can also be constructed as a single unit with the battery and cartridge built in. Either one or both of the cartridge and battery can be replaceable or removable. Many variations are possible.

### Device API

The technology and interface API's used to communicate with the different components of the fluid vaporization device and used for communication between different components of the fluid vaporization device can be stored and distributed as a software and/or firmware package, and can be adapted to different vaporization devices so that other vendors can create products compatible with the fluid vaporization device. For example, the API for communicating with the battery component can be licensed to a medical drug maker so that they can design cartridges which can be manipulated by the commands sent from the battery component.

### Alternative Configurations

Many embodiments of a vaporization device and related method have been disclosed herein. However, various modifications can be made without departing from the scope of the embodiments as defined by the appended claims and legal equivalents. For instance, the features described herein may be used in combination with the features described in U.S. application Ser. No. 13/615,542, filed Sep. 13, 2012, which relates to another vapor delivery device, and which is hereby incorporated by reference in its entirety.

What is claimed is:

1. A fluid vaporization device, comprising:
a casing;
a fluid reservoir disposed within the casing and adapted to hold a fluid;
a vaporization chamber disposed within the casing and separated from the fluid reservoir by a partition;
a wick element extending through the partition into the fluid reservoir and the vaporization chamber, the wick element being adapted to transfer fluid from the fluid reservoir to the vaporization chamber;
a heating element operable to heat at least a portion of the wick element that extends into the vaporization chamber, thereby vaporizing at least a portion of the fluid transferred from the fluid reservoir to the vaporization chamber by the wick element; and
an outlet extending from the vaporization chamber to an opening in the casing.

2. The fluid vaporization device of claim 1, wherein at least a portion of the wick element comprises poly-lactic-acid.

3. The fluid vaporization device of claim 1, wherein at least a portion of the wick element comprises a porous ceramic material.

4. The fluid vaporization device of claim 3, wherein the porous ceramic material includes a plurality of pores having a pre-determined size to thereby control the rate of transfer of fluid from fluid reservoir to the vaporization chamber.

5. The fluid vaporization device of claim 4, wherein the pores have an average diameter of less than or equal to 100 microns.

6. The fluid vaporization device of claim 1, further comprising one or more flexible sealing elements in contact with the wick element and the partition.

7. The fluid vaporization device of claim 6, wherein the one or more flexible sealing elements comprise a silicone bushing.

8. The fluid vaporization device of claim 1, wherein at least a portion of the wick element comprises cotton, polyester, hemp, rayon, a metal oxide, silicon oxide, or combinations thereof.

9. The fluid vaporization device of claim 1, further comprising a thermal cutoff disposed within the casing and coupled to the heating element.

10. The fluid vaporization device of claim 1, wherein the fluid vaporization device is an electronic cigarette.

11. The fluid vaporization device of claim 1, wherein the vaporization chamber includes one or more grooves positioned on the external surface of the vaporization chamber, said grooves adaptable to receive one or more sealing members.

12. The fluid vaporization device of claim 11, wherein the one or more sealing members comprise O-rings.

13. A vapor delivery method, comprising:
transferring a fluid from a fluid reservoir to a vaporization chamber using a wick element;
heating at least a portion of the wick element that extends into the vaporization chamber using a heating element, thereby vaporizing at least a portion of the fluid transferred from the fluid reservoir to the vaporization chamber by the wick element; and
delivering at least a portion of the vaporized fluid from the vaporization chamber to an opening of a casing which houses the vaporization chamber and the fluid reservoir.

14. The method of claim 13, wherein at least a portion of the wick element comprises poly-lactic-acid.

15. The method of claim 13, wherein at least a portion of the wick element comprises a porous ceramic material.

16. The method of claim 15, wherein the porous ceramic material includes a plurality of pores having a pre-determined size to thereby control the rate of transfer of fluid from fluid reservoir to the vaporization chamber.

17. The method of claim 16, wherein the pores have an average diameter of less than or equal to 100 microns.

18. The method of claim 13, wherein the fluid is prevented from exiting the fluid reservoir via means other than the wick element by one or more flexible sealing elements in contact with the wick element and the partition.

19. The method of claim 18, wherein the one or more flexible sealing elements comprise a silicone bushing.

20. The method of claim 13, wherein at least a portion of the wick element comprises cotton, polyester, hemp, rayon, a metal oxide, silicon oxide, or combinations thereof.

21. The method of claim 13, further comprising deactivating the heating element when the temperature exceeds a preset threshold.

22. The method of claim 13, wherein the casing comprises at least a portion of an electronic cigarette.

23. The method of claim 13, wherein the vaporization chamber includes one or more grooves positioned on the external surface of the vaporization chamber, said grooves adaptable to receive one or more sealing members.

24. The method of claim 23, wherein the one or more sealing members comprise O-rings.

25. An electronic vaporization device, comprising:
a first casing;
a fluid reservoir disposed within the first casing and adapted to hold a fluid;
a vaporization chamber disposed within the first casing and separated from the fluid reservoir by a partition;
a wick element extending through the partition into the fluid reservoir and the vaporization chamber, the wick element being adapted to transfer fluid from the fluid reservoir to the vaporization chamber;
a heating element operable to heat at least a portion of the wick element that extends into the vaporization chamber, thereby vaporizing at least a portion of the fluid transferred from the fluid reservoir to the vaporization chamber by the wick element;
an outlet extending from the vaporization chamber to an opening in the first casing;
a second casing adapted to be coupled to the first casing; and
a battery disposed within the second casing and adapted to supply power to the heating element.

26. The fluid vaporization device of claim 25, wherein at least a portion of the wick element comprises poly-lactic-acid.

27. The fluid vaporization device of claim 25, wherein at least a portion of the wick element comprises a porous ceramic material.

28. The fluid vaporization device of claim 25, wherein the porous ceramic material includes a plurality of pores having a pre-determined size to thereby control the rate of transfer of fluid from fluid reservoir to the vaporization chamber.

29. The fluid vaporization device of claim 28, wherein the pores have an average diameter of less than or equal to 100 microns.

30. The fluid vaporization device of claim 25, further comprising one or more flexible sealing elements in contact with the wick element and the partition.

31. The fluid vaporization device of claim 30, wherein the one or more flexible sealing elements comprise a silicone bushing.

32. The fluid vaporization device of claim 25, wherein at least a portion of the wick element comprises cotton, polyester, hemp, rayon, a metal oxide, silicon oxide, or combinations thereof.

33. The fluid vaporization device of claim 25, further comprising a thermal cutoff disposed within the casing and coupled to the heating element.

34. The fluid vaporization device of claim 25, wherein the fluid vaporization device is an electronic cigarette.

35. The fluid vaporization device of claim 25, wherein the vaporization chamber includes one or more grooves positioned on the external surface of the vaporization chamber, said grooves adaptable to receive one or more sealing members.

36. The fluid vaporization device of claim 35, wherein the one or more sealing members comprise O-rings.
